(19) United States
(12) Patent Application Publication
(10) Pub. No.: US 2020/0058098 A1
(43) Pub. Date: Feb. 20, 2020

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Shinnosuke HIRAKAWA, Tokyo (JP)

(73) Assignee: FUJIFILM Corporation, Tokyo (JP)

(21) Appl. No.: 16/537,505

(22) Filed: Aug. 9, 2019

(30) Foreign Application Priority Data
Aug. 14, 2018 (JP) 2018-152776

(51) Int. Cl. G06T 3/40; G06T 7/00

(52) U.S. Cl. CPC G06T 3/4053; G06T 7/0014; G06T 2207/10072; G06T 2207/30012; G06T 7/97

(57) ABSTRACT

An image processing apparatus includes an image acquisition unit that acquires a first image and a second image acquired by capturing images of a subject including a plurality of bone parts at different times, a converted image acquisition unit that performs super-resolution processing for at least one of the first image or the second image to acquire at least one of a first converted image or a second converted image, a registration processing unit that performs a registration process for the plurality of bone parts in at least one of a combination of the first converted image and the second image, a combination of the first image and the second converted image, or a combination of the first converted image and the second converted image, and a difference image acquisition unit that applies a result of the registration process to the first image and the second image to acquire a difference image between the first image and the second image.

### CROSS REFERENCE TO RELATED APPLICATIONS

The present application claims priority under 35 U.S.C. § 119 to Japanese Patent Application No. 2018-152776 filed on Aug. 14, 2018. The above application is hereby expressly incorporated by reference, in its entirety, into the present application.

### BACKGROUND

### Technical Field

The present disclosure relates to an image processing apparatus, an image processing method, and an image processing program.

### Related Art

In recent years, with the progress of medical apparatuses, such as a computed tomography (CT) apparatus and a magnetic resonance imaging (MRI) apparatus, high-resolution three-dimensional images with higher quality have been used for image diagnosis. In particular, in a case in which a target part is the spine such as the vertebra, a bone lesion, for example, a region indicating bone metastasis can be detected by image diagnosis using a CT image and an MRI image. In many cases, in the spine, osteolytic bone metastasis that appears in the form of soluble bone as bone metastasis occurs. It is desirable to early detect osteolytic bone metastasis to prevent the degradation of the quality of life (QOL) by a bone fracture.

In image diagnosis, a technique has been known which generates a difference image from a plurality of images acquired by capturing the images of a subject with the same modality at different times to enable the observation of changes between the images for the follow-up observation of the subject. The generation of the difference image makes it easy to detect a lesion with low contrast and a small size. It is necessary to perform registration between the plurality of images in order to generate the difference image. JP2017-063936A discloses a method which identifies a plurality of bone parts included in each of a first image and a second image, associates the plurality of bone parts, and performs a registration process between images of the bone parts associated with each other, thereby performing registration for the entire subject with high accuracy.

However, for example, in some cases, while the CT image of the spine relatively recently acquired is a slice image with a thickness of 0.5 mm, the CT image of the spine acquired a relatively long time ago is a slice image with a thickness of 5 mm that is larger than 0.5 mm. In a case in which a slice image with a thickness of 5 mm is used, the boundary between the bone parts may be crushed and it may be difficult to determine the boundary. In a case in which it is difficult to determine the boundary between the bone parts, for example, it is difficult to perform the registration process using the method disclosed in JP2017-063936A. JP2018-038815A discloses a technique which performs conversion such that the resolution of an image with a low resolution is equal to the resolution of an image with a high resolution, in order to perform registration with high accuracy. However, JP2018-038815A does not disclose a configuration in which a target part is a subject including a plurality of bone parts such as the spine and the ribs.

In general, in image diagnosis, in order to maintain the reliability of diagnosis by a doctor, for example, diagnosis on the original image, that is, an image which has not been subjected to a conversion processing is required rather than diagnosis on an image subjected to super-resolution processing for increasing the resolution of image data. In JP2018-038815A, a difference image is generated using a converted image obtained by converting the original image into an image with a higher resolution. Therefore, it may be difficult to maintain the reliability of the doctor's diagnosis using the generated difference image.

### SUMMARY

The present disclosure has been made in view of the above-mentioned problems and an object of the present disclosure is to provide a technique that can maintain the reliability of the doctor's diagnosis and can acquire a difference image with a higher accuracy than a difference image generated by performing registration with the original image.

According to an aspect of the present disclosure, there is provided an image processing apparatus comprising: an image acquisition unit that acquires a first image and a second image acquired by capturing images of a subject including a plurality of bone parts at different times; a converted image acquisition unit that performs super-resolution processing for at least one of the first image or the second image to acquire at least one of a first converted image or a second converted image; a registration processing unit that performs a registration process for the plurality of bone parts included in each image in at least one of a combination of the first converted image and the second image, a combination of the first image and the second converted image, or a combination of the first converted image and the second converted image; and a difference image acquisition unit that applies a result of the registration process to the first image and the second image to acquire a difference image between the first image and the second image.

In the image processing apparatus according to the aspect of the present disclosure, the converted image acquisition unit may have a learned model which has been machine-learned so as to output a converted image obtained by performing the super-resolution processing for an input image.

In the image processing apparatus according to the aspect of the present disclosure, the registration processing unit may perform at least one of a rigid registration process or a non-rigid registration process as the registration process.

In this case, the registration processing unit may perform the non-rigid registration process after performing the rigid registration process.

In the image processing apparatus according to the aspect of the present disclosure, the bone may be a vertebra and the subject may be a spine.

In the image processing apparatus according to the aspect of the present disclosure, the registration processing unit may set at least three landmarks in each bone part and perform the registration process using the set at least three landmarks.

In the image processing apparatus according to the aspect of the present disclosure, in a case in which the bone is the vertebra and the subject is the spine, the registration processing unit may set two intersection points between a center line of a vertebral body of the vertebra and two intervertebral discs adjacent to the vertebra as the landmarks.

Here, the “vertebral body” means a cylindrical portion of the vertebra and the “center line the vertebral body included in the vertebra” means a line passing through a central axis of the cylindrical portion in the side view of the subject. In addition, for example, a line that deviates from the center in an error range can also be the “center line”.

In the image processing apparatus according to the aspect of the present disclosure, the registration processing unit may set, as the landmark, an intersection point between a plane that passes through a middle point of the two intersection points and is perpendicular to a straight line connecting the two intersection points and a center line of a spinal cord.

In addition, a point that deviates from the middle point in an error range can be the “middle point”. A plane that deviates from the vertical in an error range can be a “vertical plane”. Further, the “center line of the spinal cord” means a center line in the side view of the subject. For example, a line that deviates from the center in an error range can also be the “center line”.

According to another aspect of the present disclosure, there is provided an image processing method comprising: acquiring a first image and a second image acquired by capturing images of a subject including a plurality of bone parts at different times; performing super-resolution processing for at least one of the first image or the second image to acquire at least one of a first converted image or a second converted image; associating the plurality of bone parts included in each image in at least one of a combination of the first converted image and the second image, a combination of the first image and the second converted image, or a combination of the first converted image and the second converted image and performing a registration process between images of the bone parts associated with each other; and applying a result of the registration process to the first image and the second image to acquire a difference image between the first image and the second image.

In addition, a program that causes a computer to perform the image processing method according to the present disclosure may be provided.

According to still another aspect of the present disclosure, there is provided an image processing apparatus comprising a memory that stores commands for a computer and a processor that is configured to perform the stored commands. The processor performs a process of acquiring a first image and a second image acquired by capturing images of a subject including a plurality of bone parts at different times, a process of performing super-resolution processing for at least one of the first image or the second image to acquire at least one of a first converted image or a second converted image; a process of associating the plurality of bone parts included in each image in at least one of a combination of the first converted image and the second image, a combination of the first image and the second converted image, or a combination of the first converted image and the second converted image and performing a registration process between images of the bone parts associated with each other; and a process of applying a result of the registration process to the first image and the second image to acquire a difference image between the first image and the second image.

According to the image processing apparatus, the image processing method, and the image processing program of the disclosure, it is possible to maintain the reliability of the doctor's diagnosis and to acquire a difference image with a higher accuracy than a difference image generated by performing registration with the original image.

### BRIEF DESCRIPTION OF THE DRAWINGS

FIG. 1 is a hardware configuration diagram illustrating the outline of a diagnosis support system to which an image processing apparatus according to an embodiment of the present disclosure is applied.

FIG. 2 is a block diagram schematically illustrating the configuration of the image processing apparatus according to the embodiment of the present disclosure.

FIG. 3 is a diagram illustrating a learning model according to the embodiment of the present disclosure.

FIG. 4 is a diagram illustrating images having different slice thicknesses.

FIG. 5 is a block diagram schematically illustrating the configuration of a registration processing unit according to the embodiment of the present disclosure.

FIG. 6 is a diagram in which vertebra regions associated with each other between a first converted image and a second converted image are connected by arrows.

FIG. 7 is a diagram illustrating a method for setting landmarks in each vertebra region.

FIG. 8 is a diagram illustrating a method that generates images of each vertebra region and performs registration.

FIG. 9 is a diagram illustrating vertebra regions in a converted composite image and a composite original image.

FIG. 10 is a diagram illustrating an example of a superimposed image.

FIG. 11 is a flowchart illustrating a process performed in the embodiment of the present disclosure.

FIG. 12 is a flowchart illustrating a registration process.

FIG. 13 is a flowchart illustrating a difference image acquisition process.

FIG. 14 is a diagram illustrating an example of a method for generating a partial difference image.

### DETAILED DESCRIPTION

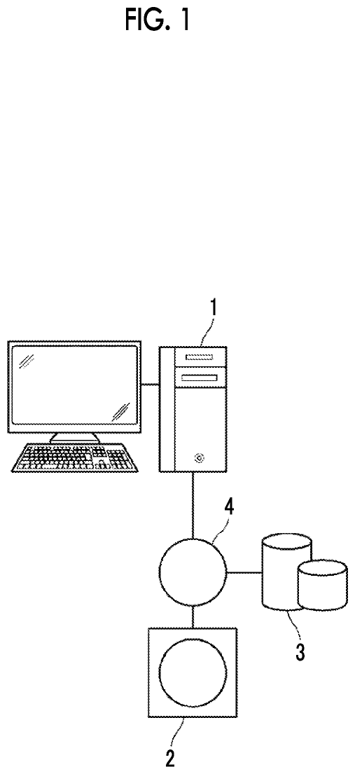

Hereinafter, embodiments of the disclosure will be described with reference to the drawings. FIG. 1 is a hardware configuration diagram illustrating the outline of a diagnosis support system to which an image processing apparatus according to an embodiment of the disclosure is applied. As illustrated in FIG. 1, in the diagnosis support system, an image processing apparatus 1, a three-dimensional imaging apparatus 2, and an image storage server 3 according to this embodiment are connected through a network 4 so as to communicate with each other.

The three-dimensional imaging apparatus 2 captures an image of a diagnosis target part of a subject to generate a three-dimensional image of the part. Specifically, the three-dimensional imaging apparatus 2 is, for example, a CT apparatus, an MRI apparatus, and a positron emission tomography (PET) apparatus. The three-dimensional image formed by a plurality of slice images generated by the three-dimensional imaging apparatus 2 is transmitted to the image storage server 3 and is then stored therein. In addition, in this embodiment, the diagnosis target part of the subject that is a patient is the vertebra, the three-dimensional imaging apparatus 2 is a CT apparatus, a CT image of the spine including the vertebra of the subject is generated as the three-dimensional image.

The image storage server 3 is a computer that stores and manages various types of data and comprises a high-capacity external storage device and database management software. The image storage server 3 performs communication with other apparatuses through the wired or wireless network 4 to transmit and receive, for example, image data. Specifically, the image storage server 3 acquires various types of data including image data of the three-dimensional image generated by the three-dimensional imaging apparatus 2 through the network, stores the acquired data in a recording medium, such as a high-capacity external storage device, and manages the data. In addition, the storage format of the image data and the communication between the apparatuses through the network 4 are based on a protocol such as Digital Imaging and Communication in Medicine (DICOM). In this embodiment, the image storage server 3 stores three-dimensional images which are the CT images of the spine including the vertebra of the subject for each of the examinations performed for the same subject at different times. The three-dimensional image is stored together with the identification information of the patient.

The image processing apparatus 1 is configured by installing an image processing program according to the present disclosure in one computer. The computer may be a workstation or a personal computer that is directly operated by a doctor for diagnosis or may be a server computer that is connected with them through the network. The image processing program is recorded on a recording medium, such as a digital versatile disc (DVD) or a compact disc read only memory (CD-ROM), and is then distributed. The image processing program is installed in the computer from the recording medium. Alternatively, the image processing program is stored in a storage device of a server computer connected to the network, or is stored in a network storage so as to be accessed from the outside, is downloaded to the computer used by the doctor on request, and is then installed in the computer.

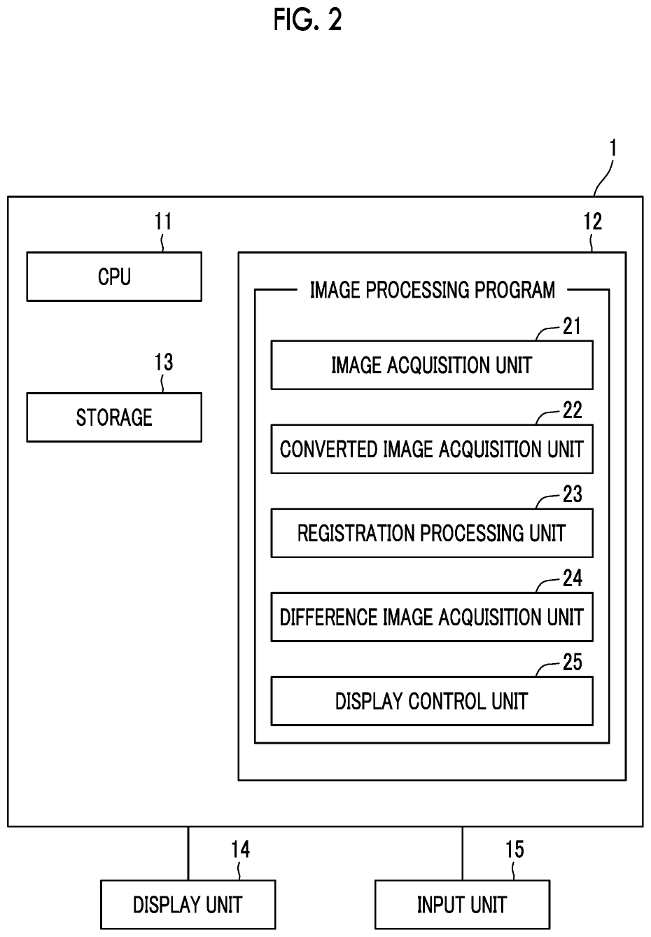

FIG. 2 is a diagram schematically illustrating the configuration of the image processing apparatus according to the embodiment of the present disclosure which is implemented by installing the image processing program in a computer. As illustrated in FIG. 2, the image processing apparatus 1 has the configuration of a standard workstation and comprises a central processing unit (CPU) 11, a memory 12, and a storage 13. In addition, a display unit 14 including, for example, a liquid crystal display and an input unit 15 including, for example, a keyboard and a mouse are connected to the image processing apparatus 1. The display unit 14 displays, for example, first and second three-dimensional images OG1 and OG2, first and second converted images TG1 and TG2, and a difference image. The input unit 15 receives various settings input by a user and receives, for example, the input of the setting of the identification information of the patient and the input of the setting of landmarks which will be described below. In addition, a touch panel may be used so as to function as the display unit 14 and the input unit 15.

The storage 13 includes, for example, a hard disk drive and a solid state drive (SSD). The storage 13 stores various kinds of information which include an examination image of the subject and information required for processes and are acquired from the image storage server 3 through the network 4.

Further, the memory 12 stores the image processing program. The image processing program defines the following processes as the processes performed by the CPU 11: an image acquisition process that acquires a first three-dimensional image and a second three-dimensional image obtained by capturing the images of the subject including the spine at different times; a converted image acquisition process that performs super-resolution processing for at least one of the first three-dimensional image or the second three-dimensional image to acquire at least one of a first converted image or a second converted image; a registration process that performs a registration process for a plurality of bones included in each image in at least one of a combination of the first converted image and the second three-dimensional image, a combination of the first three-dimensional image and the second converted image, or a combination of the first converted image and the second converted image; a difference image acquisition process that applies the result of the registration process to the first three-dimensional image and the second three-dimensional image to acquire a difference image between the first three-dimensional image and the second three-dimensional image; and a display control process that displays various kinds of images on the display unit 14.

Then, the CPU 11 performs these processes according to the program such that the computer functions as an image acquisition unit 21, a converted image acquisition unit 22, a registration processing unit 23, a difference image acquisition unit 24, and a display control unit 25.

The image acquisition unit 21 reads and acquires two three-dimensional images which have been obtained by capturing the images of the spine of the patient at different times and include the identification information of the patient input by the user through the input unit 15 from the image storage server 3 on the basis of the identification information. In addition, in a case in which three-dimensional images have been stored in the storage 13, the image acquisition unit 21 may acquire the three-dimensional images from the storage 13.

The image acquisition unit 21 may acquire, as the two three-dimensional images captured at different times, a three-dimensional image captured in the past and a current three-dimensional image captured this time or two three-dimensional images captured at different times in the past. In this embodiment, it is assumed that the past three-dimensional image and the current three-dimensional image are acquired. The past three-dimensional image is referred to as a first three-dimensional image OG1 (corresponding to a first image according to the present disclosure) and the current three-dimensional image is referred to as a second three-dimensional image OG2 (corresponding to a second image according to the present disclosure). The first three-dimensional image OG1 and the second three-dimensional image OG2 also correspond to the original images according to the present disclosure.

In this embodiment, the three-dimensional image obtained by capturing the image of the spine of the patient is acquired. However, the imaging target (subject) is not limited to the spine and may be any object as long as it includes a plurality of bone parts. For example, the imaging target may be the ribs including a plurality of left and right bone parts, hand bones including the distal phalanx, the middle phalanx, the proximal phalanx, and the metacarpal, arm bones including the humerus, the ulna, and the radius, and leg bones including the femur, the patella, the tibia, and the fibula.

The bone part means the configuration unit of a partial bone that forms the subject, such as the spine and the ribs. However, the bone part may not necessarily be one bone. For example, for a part that is less likely to be deformed due to a fracture and the movement of the subject, a group of a plurality of bones, that is, the configuration unit of one bone forming the subject may be handled as the bone part.

In addition, for the bone part, not only a region extracted by, for example, image processing, but also a region obtained by expanding the extracted region at a predetermined ratio may be handled as a bone region.

Further, volume data including tomographic images, such as axial tomographic images, sagittal tomographic images, and coronal tomographic images, may be acquired as the three-dimensional images or the tomographic images may be acquired as the three-dimensional images.

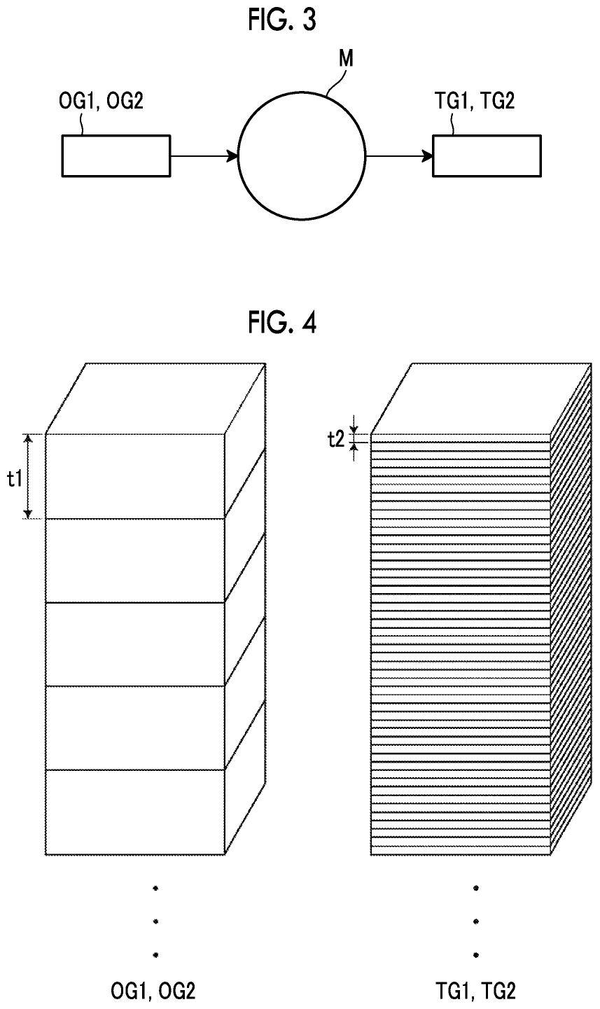

The converted image acquisition unit 22 performs super-resolution processing for the first three-dimensional image OG1 and the second three-dimensional image OG2 to acquire a first converted image TG1 and a second converted image TG2. For example, the converted image acquisition unit 22 according to the present disclosure has a learned model which has been machine-learned so as to output a converted image obtained by performing super-resolution processing for an input three-dimensional image. FIG. 3 is a diagram illustrating a learning model according to the embodiment of the present disclosure and FIG. 4 is a diagram illustrating images with different slice thicknesses.

A learned model M is a neural network which has been subjected to deep learning to generate a converted image obtained by performing super-resolution processing for a three-dimensional image from the three-dimensional image. The learned model M is learned by using a plurality of data sets of three-dimensional images with different resolutions for each ratio of the resolution of image data after super-resolution processing to the resolution of image data before super-resolution processing (hereinafter, referred to as a multiplying factor of super-resolution processing). In addition, the learned model M may be, for example, a support vector machine (SVM), a convolutional neural network (CNN), and a recurrent neural network (RNN), in addition to the neural network subjected to deep learning.

As illustrated in FIG. 3, the learned model M that has been learned as described above derives the first converted image TG1 on the basis of the first three-dimensional image OG1 and derives the second converted image TG2 on the basis of the second three-dimensional image OG2. The converted image acquisition unit 22 acquires the first converted image TG1 and the second converted image TG2 derived by the learned model M. In the present disclosure, as an embodiment, as illustrated in FIG. 4, CT images including slice images with a thickness t1=5 mm are the first three-dimensional images OG1 and the second three-dimensional image OG2 and the first converted image TG1 and the second converted image TG2 obtained by performing super-resolution processing for the first three-dimensional image OG1 and the second three-dimensional image OG2, respectively, are CT images including slice images with a thickness t2=0.5 mm. In addition, the thickness of the slice image is not limited thereto and the slice image may have any thickness as long as t1>t2 is satisfied.

The super-resolution processing performed by the converted image acquisition unit 22 is not limited to the above. For example, a super-resolution processing device comprising a conversion unit which performs super-resolution processing for input image data and outputs image data having a higher resolution than the input image data and in which the ratio of the image data output from the conversion unit to the image data input to the conversion unit is fixed, a down-sampling unit that performs a down-sampling process for the image data input to the conversion unit or the image data output from the conversion unit, and a processing unit that adjusts a sampling rate in the down-sampling process on the basis of a resolution ratio and adjusts the resolution of the image data to be output may be used to use super-resolution processing that can generate image data with a resolution corresponding to any magnification other than a predetermined magnification or other known types of super-resolution processing may be used.

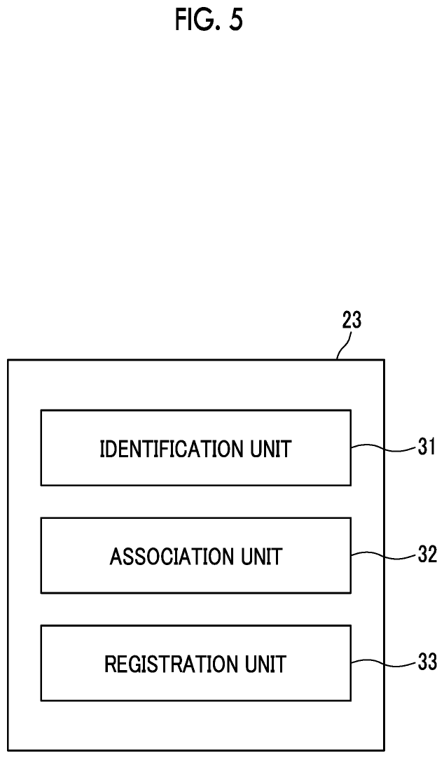

The registration processing unit 23 performs a registration process for a plurality of vertebrae included in each of the first converted image TG1 and the second converted image TG2. FIG. 5 is a block diagram schematically illustrating the configuration of the registration processing unit 23 according to the embodiment of the present disclosure. The registration processing unit 23 includes an identification unit 31, an association unit 32, and a registration unit 33.

The identification unit 31 performs a process of identifying a plurality of vertebrae forming the spine included in each of the first converted image TG1 and the second converted image TG2. A known method, such as a method using a morphology operation, a region expansion method based on a seed point, and a method for determining a vertebral body position described in JP2009-207727A may be used as the process of identifying the vertebrae. In addition, the identification unit 31 identifies an intervertebral disc region interposed between adjacent vertebra regions. A known method, such as the above-described region expansion method, may be used as the process of identifying the intervertebral disc region.

The association unit 32 associates each vertebra region included in the first converted image TG1 with each vertebra region included in the second converted image TG2. Specifically, the association unit 32 calculates correlation values for all of combinations of the vertebra regions between the first converted image TG1 and the second converted image TG2, using the pixel values (for example, CT values) of each vertebra region. In a case in which the correlation value is equal to or greater than a predetermined threshold value, it is determined that the combinations of the vertebra regions having the correlation value are combinations to be associated with each other. For example, zero-mean normalized cross-correlation (ZNCC) may be used to calculate the correlation value. However, the correlation value calculation method is not limited thereto and other calculation methods may be used.

In the embodiment of the present disclosure, the identification unit 31 and the association unit 32 perform the same process as that for the first converted image TG1 and the second converted image TG2 for the first three-dimensional image OG1 and the second three-dimensional image OG2 in addition to the first converted image TG1 and the second converted image TG2.

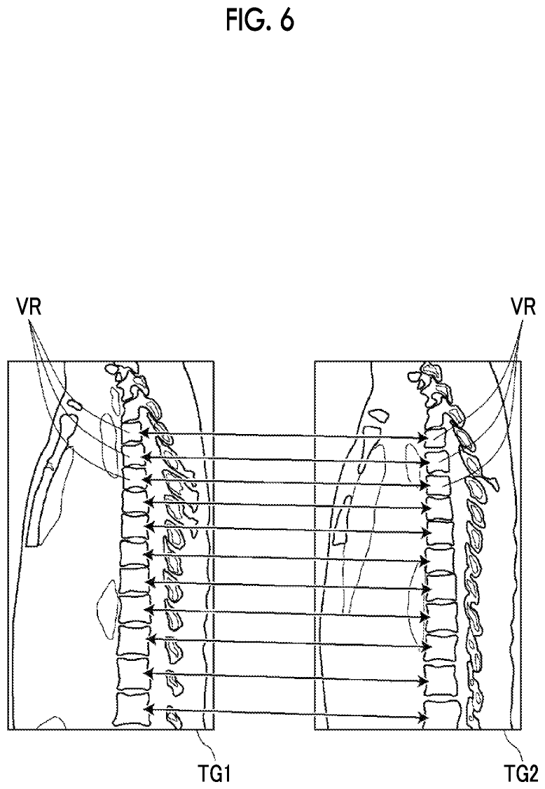

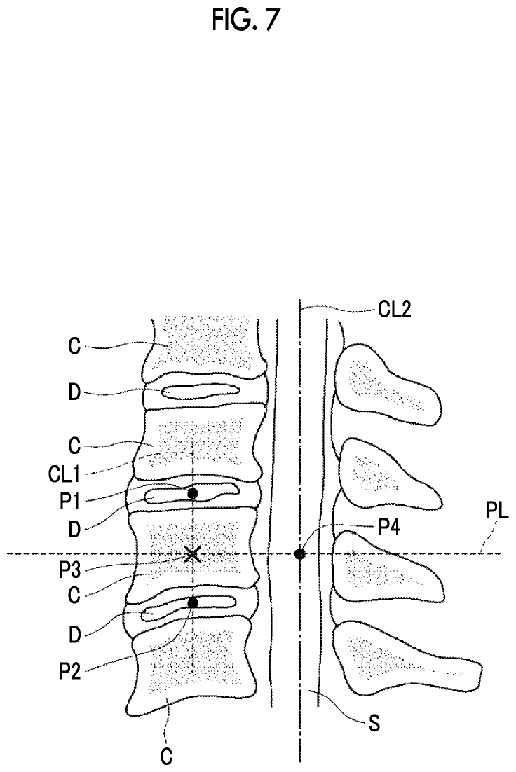

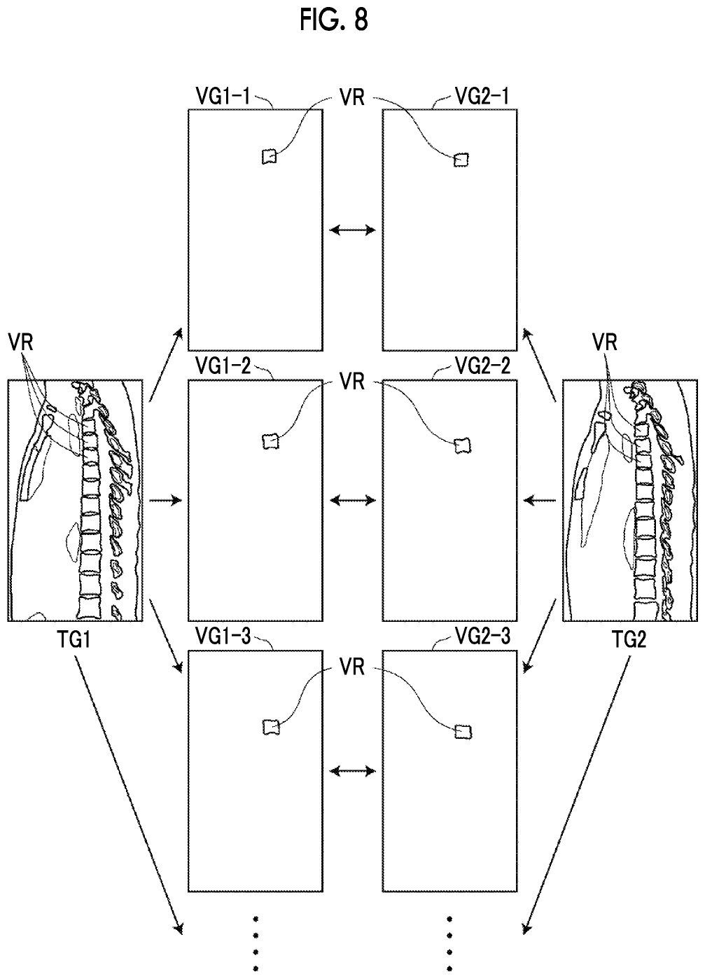

The registration unit 33 performs a process of registering the images of vertebra regions VR associated with each other as illustrated in FIG. 6 for each combination of the vertebra regions VR. FIG. 6 is a diagram in which the vertebra regions associated with each other in the first converted image TG1 and the second converted image TG2 are connected by arrows. FIG. 7 is a diagram illustrating a method for setting landmarks in each vertebra region. FIG. 8 is a diagram illustrating a method for generating the images of each vertebra region and registering the images. In addition, tomographic images illustrated in FIG. 6, FIG. 8, and FIG. 10 which will be described below are deformed such that a center line CL1 is a straight line. Further, FIG. 7 is a side view of the subject (patient).

First, the registration unit 33 sets landmarks in each vertebra region VR included in each of the first and second converted images TG1 and TG2. For example, as illustrated in FIG. 7, the registration unit 33 sets, as the landmarks, intersection points P1 and P2 between intervertebral discs D present in the upper and lower parts of the vertebra region VR and a center line CL1 of a vertebral body C in the vertebra region VR. In addition, the registration unit 33 sets, as a third landmark, an intersection point P4 between a plane PL that passes through a middle point P3 (represented by x in FIG. 7) of the intersection point P1 and the intersection point P2 and is perpendicular to a straight line passing through the intersection point P1 and the intersection point P2 and a center line CL2 of the spinal cord S.

In addition, for example, the center line CL1 of the vertebral body may be calculated by connecting the centers of gravity of each vertebral region with a curve using spline interpolation.

As in this embodiment, three landmarks are set on the basis of anatomical features to perform three-dimensional registration with high accuracy. The number of landmarks is not limited to three and four or more landmarks may be set. In this case, it is possible to perform registration with higher accuracy. Further, in this embodiment, three landmarks are set in order to perform three-dimensional registration. However, for example, in a case in which two-dimensional registration between tomographic images is performed, only two landmarks may be set.

Then, as illustrated in FIG. 8, the registration unit 33 extracts each vertebra region VR from each of the first converted image TG1 and the second converted image TG2 to generate first vertebra images VG1 and second vertebra images VG2 for each vertebra region VR as three-dimensional images. Then, the registration unit 33 performs a registration process between the first and second vertebra images VG1 and VG2 for each of the vertebra regions VR associated with each other. In this embodiment, registration is performed, using the second vertebra image VG2 for each vertebra region VR generated from the second converted image TG2 which is the current three-dimensional image as a fixed image and the first vertebra image VG1 for each vertebra region VR generated from the first converted image TG1 which is the past three-dimensional image as an image to be moved and deformed. In addition, as illustrated in FIG. 8, the first vertebra images VG1 are represented by first vertebra images VG1-1, VG1-2, VG1-3, . . . and the second vertebra images VG2 are represented by second vertebra images VG2-1, VG2-2, VG2-3, . . . . Hereinafter, the first vertebra images VG1-1, VG1-2, VG1-3, . . . are generically referred to as the first vertebra images VG1 and the second vertebra images VG2-1, VG2-2, VG2-3, . . . are generically referred to as the second vertebra images VG2.

First, the registration unit 33 performs registration using three landmarks which are set in each of the first vertebra images VG1 and the second vertebra images VG2 corresponding to the first vertebra images VG1. Specifically, the registration unit 33 performs registration by moving the first vertebra images VG1 such that the distance between corresponding landmarks is the shortest.

Then, the registration unit 33 performs a rigid registration process on the basis of the first vertebra images VG1 and the second vertebra images VG2 corresponding to the first vertebra images VG1 which have been subjected to the registration using three landmarks. For example, a process using an iterative closest point (ICP) method may be used as the rigid registration process. In addition, other known methods may be used.

Then, the registration unit 33 performs a non-rigid registration process on the basis of the first vertebra images VG1 and the second vertebra images VG2 corresponding to the first vertebra image VG1 which have been subjected to the rigid registration process. For example, a process using a free-form deformation (FFD) method and a process using a thin-plate spline (TPS) method may be used as the non-rigid registration process. In addition, other known methods may be used.

That is, the registration unit 33 performs three registration processes of the registration process using three landmarks, the rigid registration process, and the non-rigid registration process for the first vertebra images VG1 and the second vertebra images VG2 corresponding to the first vertebra images VG1. In this embodiment, as such, three registration processes are performed. However, only the rigid registration process and the non-rigid registration process may be performed.

Then, the registration unit 33 combines the first vertebra images VG1 subjected to the three registration processes as described above to generate a converted composite image CTG1. Specifically, the registration unit 33 sets an initial value image which is a three-dimensional image having the same size as the second converted image TG2 and in which all of pixel values are zero and sequentially combines the first vertebra images VG1 for each vertebra region on the initial value image to generate the converted composite image CTG1.

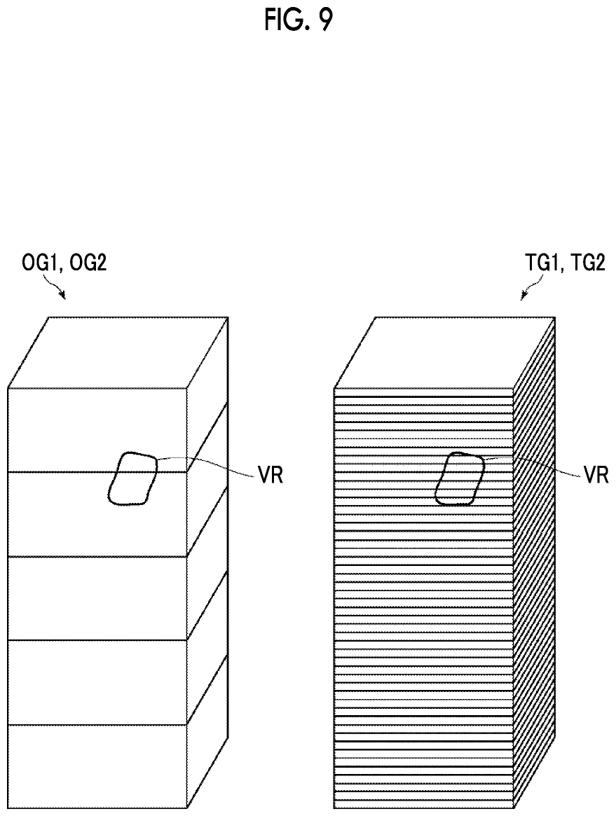

Then, returning to FIG. 2, the difference image acquisition unit 24 applies the result of the registration process by the registration processing unit 23 to the first three-dimensional image OG1 and the second three-dimensional image OG2 to acquire a difference image between the first three-dimensional image OG1 and the second three-dimensional image OG2. FIG. 9 is a diagram illustrating a vertebra region in each of the converted composite image and the composite original image.

As illustrated in FIG. 9, the difference image acquisition unit 24 generates a first composite original image COG1 in which the vertebra region VR is located at a position corresponding to the vertebra region VR of the converted composite image CTG1. The difference image acquisition unit 24 extracts each vertebra region VR from the first three-dimensional image OG1 to generate first original vertebra images VO1 (VO1-1, VO1-2, VO1-3, . . . ) for each vertebra region VR as one three-dimensional image. Then, the difference image acquisition unit 24 moves and deforms the first original vertebra image VO1 by an amount corresponding to the amount of movement and deformation of the first vertebra image VG1 by the registration unit 33. In general, the numbers of pixels of a three-dimensional image in three directions are the numbers of pixels of the three-dimensional image in the x direction, the y direction, and the z direction. The actual size per pixel is the size (for example, 0.5 mm×0.5 mm×0.5 mm) of an image represented by one pixel (voxel) in the three-dimensional image. Here, the image size B1 of the first and second three-dimensional images OG1 and OG2 is larger than the image size B2 of the first and second converted images TG1 and TG2.

For example, in a case in which B1:B2 is 10:1 and the registration unit 33 moves the first vertebra image VG1 by 10 voxels in the x direction and by 20 voxels in the y direction, the difference image acquisition unit 24 moves the first original vertebra image VO1 by 1 voxel in the x direction and by two voxels in the y direction. In addition, in a case in which the registration unit 33 moves the first vertebra image VG1 by a value less than 10 voxels, the difference image acquisition unit 24 does not move the first original vertebra image VO1. However, the technology according to the present disclosure is not limited thereto. For example, in a case in which the registration unit 33 moves the first vertebra image VG1 by the number of voxels that is equal to or greater than 0 and less than 5, the difference image acquisition unit 24 does not move the first original vertebra image VO1. In a case in which the registration unit 33 moves the first vertebra image VG1 by the number of voxels that is equal to or greater than 5 and equal to or less than 10, the difference image acquisition unit 24 may move the first original vertebra image VO1 by 1 voxel. In this way, the difference image acquisition unit 24 moves and deforms the first original vertebra image VO1 by an amount corresponding to the amount of movement and deformation of the first vertebra image VG1.

Then, the difference image acquisition unit 24 combines the first original vertebra images VO1 subjected to the registration process as described above to generate a first composite original image COG1. Specifically, the difference image acquisition unit 24 sets an initial value image which is a three-dimensional image having the same size as the second three-dimensional image OG2 and in which all of pixel values are zero and sequentially combines the first original vertebra images VO1 of each vertebra region of the first three-dimensional image OG1 on the initial value image to generate a composite image. In the first composite original image COG1 generated as described above, as illustrated in FIG. 9, the vertebra region VR is located at a position corresponding to the position of the vertebra region VR in the converted composite image CTG1.

Then, the difference image acquisition unit 24 calculates the difference between the generated first composite original image COG1 and the second three-dimensional image OG2 to generate a difference image and acquires the difference image. Generally known methods can be used as the difference image generation method. In the acquired difference image, a lesion, such as the osteolytic bone metastasis, which is not present in the first three-dimensional image OG1 captured in the past and is present in the second three-dimensional image OG2 captured this time is highlighted.

The display control unit 25 superimposes the difference image acquired by the difference image acquisition unit 24 on the second three-dimensional image OG2 to generate a superimposed image and displays the superimposed image on the display unit 14. Specifically, the display control unit 25 assigns preset colors to the difference image to generate a color image and superimposes the color image on the second three-dimensional image OG2 which is a black-and-white image to generate a superimposed image. FIG. 10 is a diagram illustrating an example of the superimposed image. In FIG. 10, a portion indicated by an arrow is an image of bone metastasis appearing on the difference image.

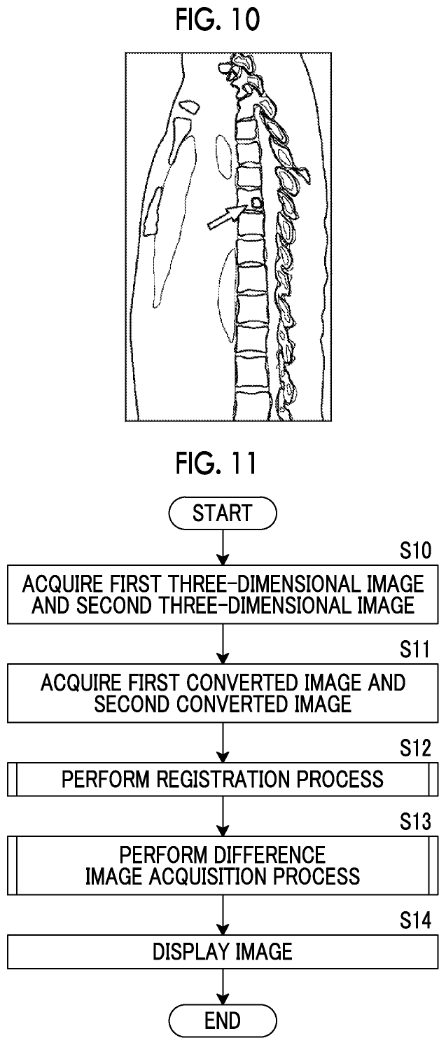

Next, a process performed in this embodiment will be described. FIG. 11 is a flowchart illustrating a process performed in the embodiment of the present disclosure.

First, the image acquisition unit 21 acquires a first three-dimensional image OG1 and a second three-dimensional image OG2 obtained by capturing the images of the patient at different times, on the basis of, for example, the identification information of the patient input by the user (Step S10).

Then, the converted image acquisition unit 22 performs super-resolution processing for the first three-dimensional image OG1 and the second three-dimensional image OG2 acquired by the image acquisition unit 21 to acquire a first converted image TG1 and a second converted image TG2 (Step S11).

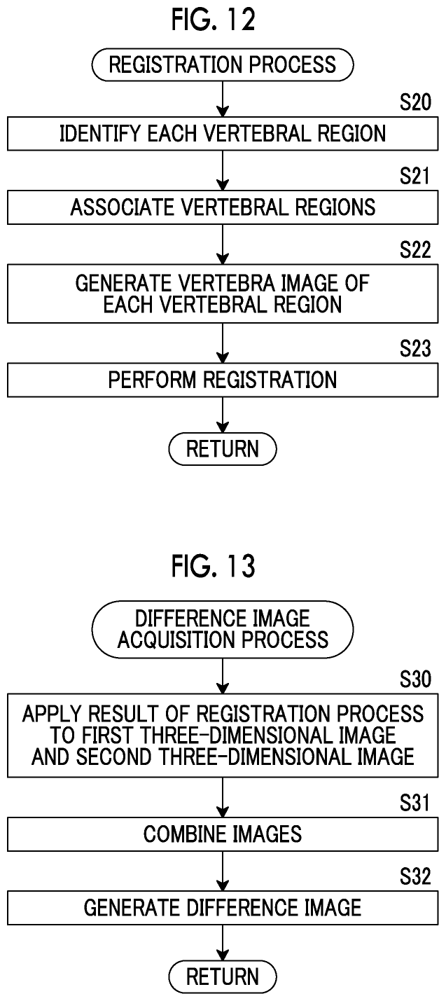

Then, the registration processing unit 23 performs a registration process (Step S12). FIG. 12 is a flowchart illustrating the registration process. As illustrated in FIG. 12, in the registration processing unit 23, first, the identification unit 31 identifies each vertebra region VR included in each of the first and second converted images TG1 and TG2 and the first and second three-dimensional images OG1 and OG2 (Step S20).

The association unit 32 associates each vertebra region VR included in the first three-dimensional image OG1 and each vertebra region VR included in the second three-dimensional image OG2 with each vertebra region VR included in the first converted image TG1 and each vertebra region VR included in the second converted image TG2, respectively (Step S21).

Then, the registration unit 33 extracts each vertebra region VR from each of the first converted image TG1 and the second converted image TG2 to generate first and second vertebra images VG1 and VG2 for each vertebra region VR (Step S22). Then, the registration unit 33 performs the registration process between the first vertebra images VG1 generated from the first converted image TG1 and the second vertebra images VG2 for each vertebra region generated from the second converted image TG2 (Step S23). Specifically, three processes, that is, the registration process using three landmarks, the rigid registration process, and the non-rigid registration process are performed as the registration process.

Then, returning to FIG. 11, the difference image acquisition unit 24 performs a difference image acquisition process (Step S13). FIG. 13 is a flowchart illustrating the difference image acquisition process. As illustrated in FIG. 13, the difference image acquisition unit 24 applies the result of the registration process illustrated in FIG. 12 to the first three-dimensional image OG1 and the second three-dimensional image OG2 (Step S30). Specifically, the difference image acquisition unit 24 extracts each vertebra region VR from the first three-dimensional image OG1 to generate first original vertebra images VO1 (VO1-1, VO1-2, VO1-3, . . . ) for each vertebra region VR as one three-dimensional image. Then, the difference image acquisition unit 24 moves and deforms the first original vertebra image VO1 by an amount corresponding to the amount of movement and deformation of the first vertebra image VG1.

Then, the difference image acquisition unit 24 combines the first original vertebra images VO1 for each vertebra region of the first three-dimensional image OG1 subjected to the registration process to generate a first composite original image COG1 (Step S31) and calculates the difference between the first composite original image COG1 and the second three-dimensional image OG2 to generate a difference image (Step S32).

Returning to FIG. 11, the display control unit 25 superimposes the difference image on the second three-dimensional image OG2 to generate a superimposed image and displays the generated superimposed image on the display unit 14 (Step S14).

As such, according to this embodiment, the images of the spine including a plurality of vertebrae are captured at different times to acquire the first three-dimensional image OG1 and the second three-dimensional image OG2. Then, super-resolution processing is performed for the first three-dimensional image OG1 and the second three-dimensional image OG2 to acquire the first converted image TG1 and the second converted image TG2. In addition, the registration process is performed for a plurality of vertebrae included in the first converted image TG1 and the second converted image TG2 between the first converted image TG1 and the second converted image TG2. Then, the result of the registration process is applied to the first three-dimensional image OG1 and the second three-dimensional image OG2, that is, the original images to acquire the difference image between the first three-dimensional image OG1 and the second three-dimensional image OG2. As such, since the registration process is performed for the first converted image TG1 and the second converted image TG2 having a higher resolution than the first three-dimensional image OG1 and the second three-dimensional image OG2, registration for the entire spine can be performed with higher accuracy than registration using the first three-dimensional image OG1 and the second three-dimensional image OG2. In addition, since the result of the registration process is applied to the first three-dimensional image OG1 and the second three-dimensional image OG2 to acquire the difference image between the first three-dimensional image OG1 and the second three-dimensional image OG2, it is possible to maintain the reliability of the doctor's diagnosis, as compared to the difference image between the first converted image TG1 and the second converted image TG2 which are virtual images.

Further, in the above-described embodiment, the first and second vertebra images VG1 and VG2 for each vertebra region are generated from the first converted image TG1 and the second converted image TG2, respectively, and the registration process between the first and second vertebra images VG1 and VG2 for each vertebra region is performed. However, the first and second vertebra images VG1 and VG2 for each vertebra region may not be necessarily generated from the first converted image TG1 and the second converted image TG2, respectively. For example, the first vertebra images VG1 for each vertebra region may be generated only from the first converted image TG1, the second converted image TG2 which is a fixed image may be maintained without being changed, and the registration process may be performed between the first vertebra images VG1 for each vertebra region generated from the first converted image TG1 and the vertebra regions VR in the second converted image TG2 which corresponds to the vertebra regions. Conversely, the second vertebra images VG2 for each vertebra region may be generated only from the second converted image TG2 and the first converted image TG1 may be maintained without being changed.

Furthermore, in the above-described embodiment, the first original vertebra images VO1 for each vertebra region generated from the first three-dimensional image OG1 are combined to generate the first composite original image COG1 and the difference image between the first composite original image COG1 and the second three-dimensional image OG2 is generated. However, the disclosure is not limited thereto. The difference image acquisition unit 24 may extract each vertebra region VR from the second three-dimensional image OG2 to generate second original vertebra images VO2 (VO2-1, VO2-2, VO2-3, . . . ) for each vertebra region VR as one three-dimensional image, may calculate the differences between the first original vertebra images VO1 for each vertebra region VR and the second original vertebra images VO2 for each vertebra region VR, to which the result of the registration process has been applied, to generate a plurality of partial difference images, and may combine the plurality of partial difference images to generate a difference image. In a case in which the partial difference images are generated as described above, the first original vertebra images VO1 and the second original vertebra images VO2 for each vertebra region may not be necessarily generated from the first and second three-dimensional images OG1 and OG2. For example, only the first original vertebra images VO1 for each vertebra region may be generated and the second three-dimensional image OG2 which is a fixed image may be maintained without being changed.

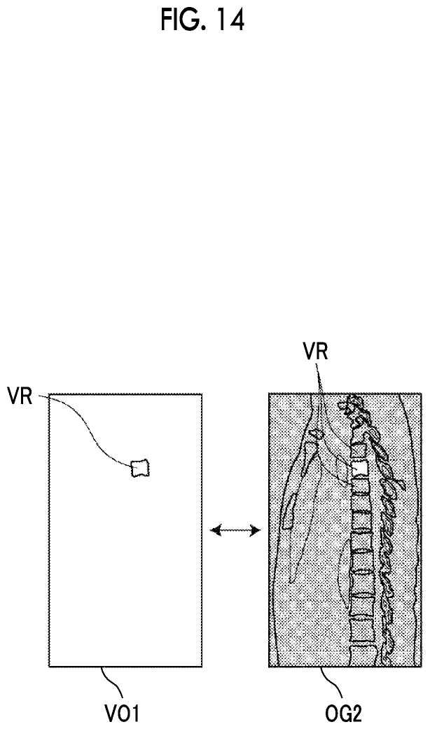

Here, FIG. 14 is a diagram illustrating an example of a partial difference image generation method. In a case in which the partial difference image is generated, as illustrated in FIG. 14, a mask process may be performed for a region (a portion illustrated in gray in FIG. 14) other than the vertebra region to be subtracted in the second three-dimensional image OG2 and the differences between the second three-dimensional image OG2 subjected to the mask process and the first original vertebra images VO1 for each vertebra region of the first three-dimensional image may be calculated to generate the partial difference images. Conversely, the second original vertebra images VO2 for each vertebra region may be generated from the second three-dimensional image OG2 and the first three-dimensional image OG1 may be maintained without being changed. In this state, the partial difference images may be generated by the same method as described above.

Further, in the above-described embodiment, the three-dimensional images OG1 and OG2 obtained by capturing the images of the spine of the patient are acquired. However, as described above, the imaging target (subject) is not limited to the spine and may be any object as long as it includes a plurality of bone parts. For example, the imaging target may be the ribs, hand bones, arm bones, and leg bones. For example, the ribs include the first to twelfth ribs. In the first converted image TG1 and the second converted image TG2 obtained by performing super-resolution processing for the first three-dimensional image OG1 and the second three-dimensional image OG2, respectively, the first to twelfth ribs may be identified and the registration process may be performed for each of the first to twelfth ribs corresponding to each other between the first converted image TG1 and the second converted image TG2. Then, the difference between the three-dimensional images of each rib region, to which the result of the registration process has been applied, may be calculated to generate a difference image.

In the case of the hand bones, in the first converted image TG1 and the second converted image TG2 obtained by performing super-resolution processing for the first three-dimensional image OG1 and the second three-dimensional image OG2, respectively, the distal phalanx, the middle phalanx, the proximal phalanx, and the metacarpal may be identified and the registration process may be performed for each of the bone parts corresponding to each other between the first converted image TG1 and the second converted image TG2. Then, the difference between the three-dimensional images of each bone part of the three-dimensional images OG1 and OG2, to which the result of the registration process has been applied, may be calculated to generate a difference image.

In the case of the arm bones, in the first converted image TG1 and the second converted image TG2 obtained by performing super-resolution processing for the first three-dimensional image OG1 and the second three-dimensional image OG2, respectively, the humerus, the ulna, and the radius may be identified and the registration process may be performed for each of the bone parts corresponding to each other between the first converted image TG1 and the second converted image TG2. Then, the difference between the three-dimensional images of each bone part of the three-dimensional images OG1 and OG2, to which the result of the registration process has been applied, may be calculated to generate a difference image.

In the case of the leg bones, in the first three-dimensional image and the second three-dimensional image, the femur, the patella, the tibia, and the fibula may be identified and the registration process may be performed for each of the bone parts corresponding to each other between the first three-dimensional image and the second three-dimensional image. Then, the difference between the three-dimensional images of each bone part of the three-dimensional images OG1 and OG2, to which the result of the registration process has been applied, may be calculated to generate a difference image.

For example, a known method, such as a region expansion method, may be used to identify each bone part, such as the above-described ribs and hand bones, in the subject.

In the above-described embodiment, super-resolution processing is performed for both the first three-dimensional image OG1 and the second three-dimensional image OG2. However, the technology according to the present disclosure is not limited thereto. For example, in a case in which one of the three-dimensional images, for example the second three-dimensional image OG2 has already had a resolution suitable for the registration process, super-resolution processing may be performed for only the other three-dimensional image, that is, the first three-dimensional image OG1. In this case, the registration process is performed between the first converted image TG1 obtained by performing super-resolution processing for the first three-dimensional image OG1 and the second three-dimensional image OG2. Then, the result of the registration process is applied to the first three-dimensional image OG1 and the second three-dimensional image OG2 to acquire a difference image between the first three-dimensional image OG1 and the second three-dimensional image OG2.

In the above-described embodiment, for example, the first image and the second image are described as three-dimensional images. However, the technology according to the present disclosure is not limited to the three-dimensional images and may be applied to two-dimensional images and four-dimensional images. Here, the four-dimensional image means a three-dimensional moving image of the heart.

In the above-described embodiment, for example, the first image and the second image are CT images. However, the technology according to the present disclosure is not limited to the CT images and the first image and the second image may be images captured by other modalities, such as MRI images and PET images.

In the above-described embodiment, as illustrated in FIG. 2, the image processing apparatus 1 includes the display control unit 25. However, the technology according to the present disclosure is not limited thereto. For example, the display control unit 25 provided in an external apparatus may be used.

In the above-described embodiment, for example, the following various processors can be used as the hardware structure of processing units performing various processes, such as the image acquisition unit 21, the converted image acquisition unit 22, the registration processing unit 23, the difference image acquisition unit 24, and the display control unit 25. The various processors include a CPU which is a general-purpose processor executing software (program) to function as various processing units as described above, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform a specific process.

One processing unit may be configured by one of the various processors or a combination of two or more processors of the same type or different types (for example, a combination of a plurality of FPGAs and a combination of a CPU and an FPGA). In addition, a plurality of processing units may be configured by one processor.

A first example of the configuration in which a plurality of processing units are configured by one processor is an aspect in which one processor is configured by a combination of one or more CPUs and software and functions as a plurality of processing units. A representative example of this aspect is a client computer or a server computer. A second example of the configuration is an aspect in which a processor that implements the functions of the entire system including a plurality of processing units using one integrated circuit (IC) chip is used. A representative example of this aspect is a system-on-chip (SoC). As such, various processing units are configured by using one or more of the various processors as a hardware structure.

In addition, specifically, an electric circuit (circuitry) obtained by combining circuit elements, such as semiconductor elements, can be used as the hardware structure of the various processors.

What is claimed is:

1. An image processing apparatus comprising:
an image acquisition unit that acquires a first image and a second image acquired by capturing images of a subject including a plurality of bone parts at different times;
a converted image acquisition unit that performs super-resolution processing for at least one of the first image or the second image to acquire at least one of a first converted image or a second converted image;
a registration processing unit that performs a registration process for the plurality of bone parts included in each image in at least one of a combination of the first converted image and the second image, a combination of the first image and the second converted image, or a combination of the first converted image and the second converted image; and
a difference image acquisition unit that applies a result of the registration process to the first image and the second image to acquire a difference image between the first image and the second image.

2. The image processing apparatus according to claim 1,
wherein the converted image acquisition unit has a learned model which has been machine-learned so as to output a converted image obtained by performing the super-resolution processing for an input image.

3. The image processing apparatus according to claim 1,
wherein the registration processing unit performs at least one of a rigid registration process or a non-rigid registration process as the registration process.

4. The image processing apparatus according to claim 3,
wherein the registration processing unit performs the non-rigid registration process after performing the rigid registration process.

5. The image processing apparatus according to claim 1,
wherein the bone is a vertebra and the subject is a spine.

6. The image processing apparatus according to claim 1,
wherein the registration processing unit sets at least three landmarks in each bone part and performs the registration process using the set at least three landmarks.

7. The image processing apparatus according to claim 2,
wherein the registration processing unit sets at least three landmarks in each bone part and performs the registration process using the set at least three landmarks.

8. The image processing apparatus according to claim 3,
wherein the registration processing unit sets at least three landmarks in each bone part and performs the registration process using the set at least three landmarks.

9. The image processing apparatus according to claim 5,
wherein the registration processing unit sets at least three landmarks in each bone part and performs the registration process using the set at least three landmarks.

10. The image processing apparatus according to claim 6,
wherein, in a case in which the bone is the vertebra and the subject is the spine, the registration processing unit sets two intersection points between a center line of a vertebral body of the vertebra and two intervertebral discs adjacent to the vertebra as the landmarks.

11. The image processing apparatus according to claim 7,
wherein, in a case in which the bone is the vertebra and the subject is the spine, the registration processing unit sets two intersection points between a center line of a vertebral body of the vertebra and two intervertebral discs adjacent to the vertebra as the landmarks.

12. The image processing apparatus according to claim 8,
wherein, in a case in which the bone is the vertebra and the subject is the spine, the registration processing unit sets two intersection points between a center line of a vertebral body of the vertebra and two intervertebral discs adjacent to the vertebra as the landmarks.

13. The image processing apparatus according to claim 9,
wherein, in a case in which the bone is the vertebra and the subject is the spine, the registration processing unit sets two intersection points between a center line of a vertebral body of the vertebra and two intervertebral discs adjacent to the vertebra as the landmarks.

14. The image processing apparatus according to claim 10,
wherein the registration processing unit sets, as the landmark, an intersection point between a plane that passes through a middle point of the two intersection points and is perpendicular to a straight line connecting the two intersection points and a center line of a spinal cord.

15. The image processing apparatus according to claim 11,
wherein the registration processing unit sets, as the landmark, an intersection point between a plane that passes through a middle point of the two intersection points and is perpendicular to a straight line connecting the two intersection points and a center line of a spinal cord.

16. The image processing apparatus according to claim 12,
wherein the registration processing unit sets, as the landmark, an intersection point between a plane that passes through a middle point of the two intersection points and is perpendicular to a straight line connecting the two intersection points and a center line of a spinal cord.

17. The image processing apparatus according to claim 13,
wherein the registration processing unit sets, as the landmark, an intersection point between a plane that passes through a middle point of the two intersection points and is perpendicular to a straight line connecting the two intersection points and a center line of a spinal cord.

18. An image processing method comprising:
acquiring a first image and a second image acquired by capturing images of a subject including a plurality of bone parts at different times;
performing super-resolution processing for at least one of the first image or the second image to acquire at least one of a first converted image or a second converted image;
associating the plurality of bone parts included in each image in at least one of a combination of the first converted image and the second image, a combination of the first image and the second converted image, or a combination of the first converted image and the second converted image and performing a registration process between images of the bone parts associated with each other; and
applying a result of the registration process to the first image and the second image to acquire a difference image between the first image and the second image.

19. A non-transitory computer-readable storage medium that stores an image processing program that causes a computer to perform:
acquiring a first image and a second image acquired by capturing images of a subject including a plurality of bone parts at different times;
performing super-resolution processing for at least one of the first image or the second image to acquire at least one of a first converted image or a second converted image;
associating the plurality of bone parts included in each image in at least one of a combination of the first converted image and the second image, a combination of the first image and the second converted image, or a combination of the first converted image and the second converted image and performing a registration process between images of the bone parts associated with each other; and
applying a result of the registration process to the first image and the second image to acquire a difference image between the first image and the second image.
